(19) United States
(12) Patent Application Publication
(10) Pub. No.: US 2002/0112001 A1
(43) Pub. Date: Aug. 15, 2002

(54) System and method for opotimizing the storage and processing of digital images on a distributed computer network

(76) Inventors: Stephen B. Sutherland, Markham (CA); Dale M. Wick, Toronto (CA)

Correspondence Address: S. Warren Hall-Dennison Associates, Suite 301, 133 Richmond Street West, Toronto, ON, M5H 2L7, CA

(21) Appl. No.: 10/067,961

(22) Filed: Feb. 8, 2002

(30) Foreign Application Priority Data
Feb. 9, 2001 (CA) 2,335,385

(51) Int. Cl. G06F 15/16

(52) U.S. Cl. 709/203

(57) ABSTRACT

The present system and method provides for the optimization of the storage, access, processing, and reprint fulfillment of digital images on a distributed computer network. It includes the steps of storing images local to where they were originally scanned and using proxies to minimize required communications bandwidth with a central community photo sharing website while delivering a rich, high-quality enlargement and reprint environment by dynamically transferring the originally scanned images to locations on the network as required.

### FIELD OF THE INVENTION

The present invention relates to a method for effective storage, access, processing and reprint fulfillment of digital images on a distributed computer network. In particular, this invention relates to a method which provides efficiencies with respect to communications bandwidth while delivering both a consistent visual image access behavior and high-quality reprints.

### BACKGROUND OF THE INVENTION

The present invention relates to an improved method and system of online storage, access, retrieval and processing of digital images and the related reprint fulfillment process. More specifically, it addresses the image quality vs. cost of transmission equation that has been a significant impediment to the sale of enlargements.

Current high-speed retail digital reprint systems date back to the initial installations in the early 1990's. One, if not the first of such installations, consisting of a Kodak RFS 2035 Film Scanner, a networked IBM PS/2 computer and Kodak XLS8300 dye sublimation printer was installed by “Your Expression Personalized Greetings Inc.” in a retail plaza in downtown Toronto in December 1993. Customers entering the store with film negatives were offered a high-speed, high-resolution (commonly referred to as “16-base”) film scan transferring the image to the networked computer. Cropping and other editing of the image then occurred on the computer and the resulting image was printed on a dye sublimation printer. Optionally, the customer could specify a name for the image (typically their initials and a frame number) and the image would then be stored on a networked file server. The networked file server, running the IBM Lan Server operating system, was attached to remote systems through a dial-up telephone line but since the 16-base image was 18 MB in size, rarely was the original image transferred without first being significantly compressed, typically using JPEG, resulting in quality loss. Thus, subsequent prints made from the transferred image were inferior to the first reprint made at time of scan.

As the internet emerged and demands for the transmission of digital images grew, common approaches to the image size vs. transmission time equation appeared. One approach, popularized by Kodak's “PhotoNet” online service, was not only to significantly JPEG compress the images before transmission, but to also significantly reduce the target original image size before compression by creating only low resolution (commonly referred to as “4-base”) scans. This meant that one entire roll of scanned negatives in the PhotoNet system could be transferred over the internet in far less time than one of the original scans made by the Your Expression system.

While there is little or no visual difference to consumers in a heavily compressed 4-base image and an original 16-base image when viewed onscreen and reprinted at sizes such as 4×6 and 5×7 inches, larger reprints and cropping operations make the compressed 4-base images inadequate. As photofinishing retailers face little (if any) profit margin on small reprints, a method is needed whereby the quality benefits of 16-base scans can be achieved using existing, affordable network bandwidth.

### SUMMARY OF THE INVENTION

The system and method of the present invention provides the user with full information and records with sufficient accuracy to place an order. Once an order is received, the full digital record is retrieved and if necessary, transmitted to an appropriate site to allow the order to be processed. In this way, only full records for which an order has been received, are transmitted and in many cases, the records may already be present with the particular premise where the full record is maintained.

The method of the present invention includes the steps of storing original film scans on a local file server and transferring proxies of such images to a central photo sharing community website, together with a pointer to the original file server and corresponding film scan; allowing an authorized user to access the community website and the particular images associated with the user; providing tools for the user to modify and adjust the images; providing an arrangement for placing an order with respect to an image or adjusted image together with the instruction set of any modifications that have been made to the image; providing said instruction set to the original file server; modifying the original image using the instruction set provided with the order information to produce a high quality image as ordered by the user and providing the image to the customer.

### BRIEF DESCRIPTION OF THE DRAWINGS

Preferred embodiments of the invention are shown in the drawings, wherein:

FIG. 1 is a schematic overview showing a community website, a series of users and a series of related retail outlets; and

FIG. 2 is a schematic showing certain features of the community website.

### DETAILED DESCRIPTION OF THE PREFERRED EMBODIMENTS

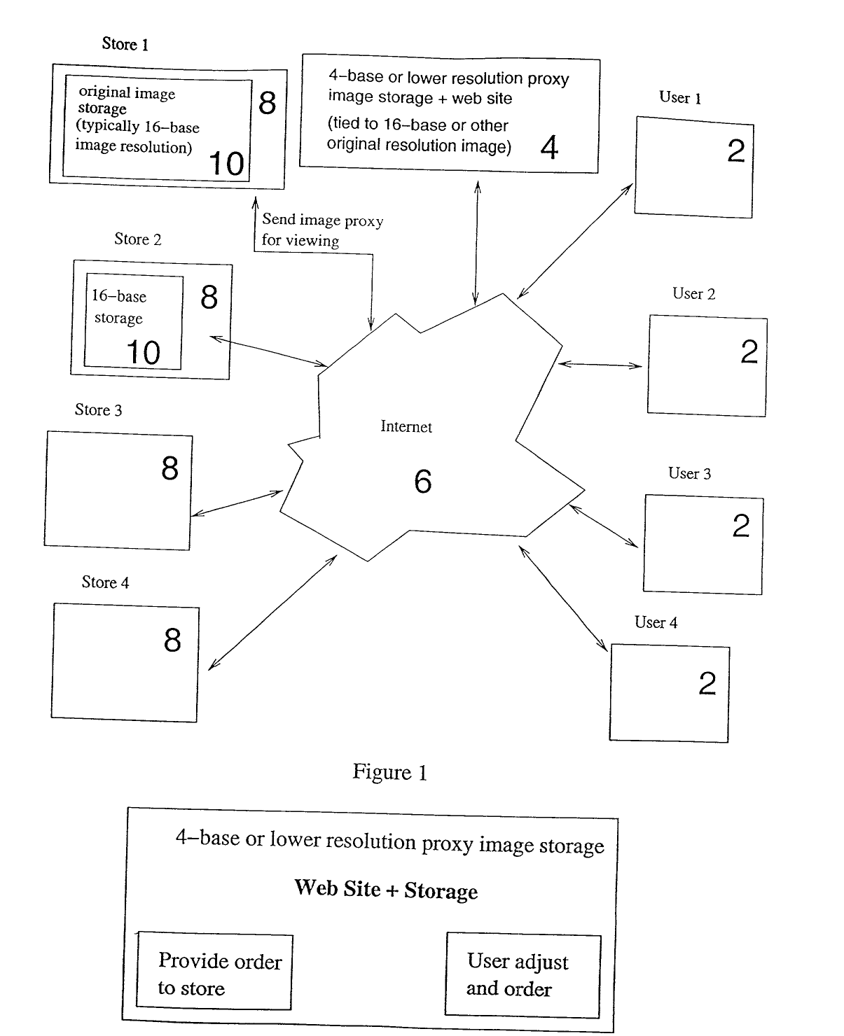

With the present arrangement as shown in FIG. 1, there can be a series of retail outlets 8 and each retail outlet 8 can include its own associated file server 10 on which full images are loaded and stored. Proxies of these images are posted to the photo sharing community website 4. The proxies of the images are of reduced quality and resolution to allow for more cost effective transmission to the community website. Any user 2 can access the community website 4 and review the authorized images and prepare modifications thereof and place an order of such images, with any of the retail outlets 8. If the order is placed with the retail outlet that originally stored the full image, then that outlet can process the full image and produce the ordered product for the customer. In some cases, the customer may have designated a different retail outlet. In this case, the original high quality image is transmitted from the first file server to the file server of the designated retail outlet. This outlet then completes the order and provides the finished product for the customer. In some cases, the retail outlets may merely send the finished product to the selected outlet using conventional means.

With this system and method, transmission of full high quality images, i.e., 16 base images (although 4 base or other resolutions are also possible), is minimized, and at least, limited to the fulfillment of orders. Proxies of the fully scanned images of reduced accuracy and resolution are transmitted to a community website. Typically, the proxies are of sufficient quality for the customer to effectively view the images over a computer network. For example, the image, when viewed on a computer monitor, will be of the same approximate quality, whether the image is a 4 base image or a 16 base image. Therefore, if a customer has 36 digital images scanned and the proxies posted to the community website, these posted images will all be of reduced quality, i.e., typically 4 base or lower resolution images. The customer may seek to modify one or two of these images and determine what modifications, enlargements and cropping, etc. that may be desired on the community website and view the modified image, in accordance with his instructions. He can then place an order for that modified image for pick up at a retail outlet.

The instructions with respect to the modified image are transferred to the retail outlet and the retail outlet will either retrieve the original high resolution image from its own database or have the high resolution image transmitted from one of its associated retail outlets. In this way, the original images are only transmitted when an order is received and only a small number of the images will actually be transmitted. This system provides the full advantages of low cost or free viewing and editing by the user, and encouragement of additional orders at a higher margin. The cost of offering this service are greatly reduced as the memory storage on the community website and transmission costs are less demanding due to the significant reduction in the quality of the image available to the user. This is basically transparent to the user as he is viewing these images, using a monitor where this reduction is not immediately apparent.

With this system, the community website provides full access to the image proxies which include a pointer or address back to the high quality original images. High quality original images are only transmitted when an order is received and often transmission is not required. Instructions with respect to image manipulation are transmitted and then used to adjust the high quality image shortly before printing at the fulfilling location.

With this arrangement, the advantage of posting images to a central website is achieved without eliminating the original high quality scan. Large reprints of high quality are achieved as the high quality original image is modified in accordance with a user determined instruction set.

In a preferred aspect of the invention, certain customers can have enhanced services and can have the original scanned images images transmitted from the original file server to the community website to support special viewing or modification. This might be necessary where a very small portion of an image is to be considered for enlargement and the quality of the previously uploaded proxy image on the web server would not be sufficient. Alternatively, these instructions can be transmitted to the original file server and only that portion of the original image, which is to be enlarged or otherwise modified, need be transmitted to the web server at the standard for the web server (i.e., typically 4 base resolution or lower). A further alternative enables the community server to send instructions to the original file server to produce a portion of the original image at a resolution desirable for the customer—such new proxy image to be transmitted directly from the original file server to the web browser of the customer under control of the community website. Again, the transmission costs in all these approaches are reduced and the desired image of the customer is provided to him at a quality which is appropriate for the viewing or modification technique at hand. This service could include a certain fee or charge.

A further opportunity for increased profit margin for retailers is in the sale of higher-resolution scans. Existing systems categorize all customers, and all images, in one group and do not recognize that the proliferation of knowledge of digital imaging is creating groups of customers who would pay for better quality film scans. Existing systems also do not recognize that some images are more valuable to such customers than others. With the present system, users can optionally specify a superior service such as long term retention of high quality images. Thus a system allowing for the dynamic categorization of images and customers based on their quality desires is achieved and appropriate compensation charged.

A further related area of this invention includes the ability to crop, edit and use images in compositions for final output through the manipulation of a lower-resolution “proxy” of the original image. Object-based procedures, such as described in “Method of Rendering an Image” U.S. Pat. No. #5903277, make this possible and negate the need to have a high-resolution original online for editing, compositing and cropping operations and this invention integrates the use of such capabilities. Furthermore, existing web-based systems which attempt to build complex compositions centrally requiring fine fonts or other detail are often faced with producing files of over 30 MB in size which have to be transmitted, with only lossless compression, to print fulfilling locations. This invention distributes the final processing of such compositions to the fulfilling locations and thus negates the need to move final compositions long distances needlessly consuming communications resources.

The overall system shown in FIG. 1 has a number of users 2 that access using the internet or other available network the storage website 4. This storage website has received from one of the various retail outlets 8, reduced quality digital records such as digital photographs which have been stored in accordance with information provided by the user. The user can then access these digital records and review them in a reduced quality which is satisfactory for review and transmission over the internet. The web storage site 4 also allows the user to modify these images, crop them, mosaic them, and a host of other tools, and preview the resulting product.

Basically the user is allowed free access to allow a host of different modifications with the possibility of a further sale for the modified image. The finished product will not use the quality of the images stored on the storage website 4 as these were of reduced accuracy suitable for transmission over a network and for display by the user. If the user decides to proceed with an enlargement, for example, which has been cropped and possibly colour corrected, an order is placed, together with the instruction set for modifying the image, and perhaps even the modified 4 base image. The user will also designate which retail outlet (or other fulfillment location) he would like to attend at or have the service completed on his behalf.

In many cases, this will be the same store that originally received his film developing or scanning, and thus, the store will have in its own 16 base (or other original resolution) storage indicated as 10, the actual detailed record. In this case, that store would then complete the order (and process the list of modifications against the original resolution images, as required) on behalf of the user and the user would pay that retail outlet or, alternatively, pay the community web service online who would compensate the retail outlet on completion of the transaction. With this arrangement, transmission of the detailed record across the network has not occurred and only the simplified images were transmitted to the storage website. This greatly reduces the complexity with respect to the storage website 4 and also greatly reduces transmission time and cost.

In some cases, the user may wish to pick up his order at a different retail outlet than the outlet that originally converted his film records to 16 base (or other original resolution) digital records. Therefore, instructions may come to store 3 whereas the actual detailed record is at the file server at store 1. Store 3 would then provide instructions to store 1 with respect to transmission of the actual digital record required to allow the order to be completed, and store 1 would transmit this record to store 3. Once again, only transmission of the required digital record is made across the network and as can be appreciated, many of the 16 base (or other original resolution) digital records will never be transmitted across the network. Furthermore, transmission of the detailed record across the network is only based on an order being placed, and therefore, the transmission costs can be built into the pricing model. Instructions arriving at Store 3 might require detailed records from multiple stores to be retrieved before more complex compositing or other operations involving multiple images can be completed at Store 3 to produce the desired print.

With this system, the convenience and encouragement is provided for the user to view his images and modify the images, using the storage website 4. This enhancement is accomplished in a cost effective manner and any reduction in quality is basically transparent to the user. As can be appreciated, the user will be reviewing these records on a monitor and the 4 base (or lower resolution) digital records will be sufficient. Furthermore, the user places an order based on the modified 4 base (or lower resolution) image and as such, the final product when it is received will be more accurate and of higher quality.

The community website 4 can also have associated therewith, a long term storage charge which is paid for by a user. For example, a user may review 36 4 base (or lower resolution proxy) images corresponding to his film that he has dropped off at store 1. Of these 36 images, he has determined that four of them are excellent records and although he does not wish to order them at this time, he does wish to pay for storage on a long term basis. These four high quality records can be transferred to the website. Such would then be available for reprint and composition orders for an extended time.

The community website 4 can also use the same proxy method to enable other users who are authorized by the owner of the images to view the images and order reprints or make compositions. Such other users might live anywhere in the world. Reprint requests would be fulfilled at a store or other contracted fulfillment location near such other users worldwide in a manner identical to the process outlined herein where the fulfilling location must retrieve, upon receipt of the order and associated image processing information, the original images from the original scanning location or, if the original images have been stored by their owner on the community website, directly from that website. In the event that at a given time of reprint order, the original images are located at both the original scanning location and the community website, the order and image processing information will contain both such pointers so that the fulfilling location can make a determination as to the best route to use to retrieve the original images.

The present system and method facilitates the online ordering, processing and production of high-quality enlargements from high-resolution (or losslessly compressed 4-base) images without incurring significant incremental transmission costs; allows customers who wish to pay for high-quality film scans and relating products the ability to do so without incurring significant costs for the retailer against all customer film scanning; and allows customers, who discover after their film has been developed and scanned, that one or more specific images are those “once in a lifetime moments” that should be preserved in a higher-resolution form.

1) The customer's account is entered into a scanning station where film frames are then scanned and the resulting images are transferred to a locally networked file server. Should the customer not have an existing account with the retailer, a number of methods of assigning an account may be used including customer's phone number, name, etc., which are not critical to the invention. Typically, these scanning stations will be scanning at 16-base or higher resolution and typically a lossless or near lossless compression is the only compression applied to such images before storage on the locally networked file server.

2) Each image is given a unique identifier automatically by the scanning station (this may consist of the time and date of the scan with a reference to the customer account, or retail location or in other manners such that every image has a unique identifier).

3) Code running on the locally networked file server produces image proxies from each stored scanned image and automatically transfers each proxy to a specialized central internet photo sharing community web site. These proxies are of adequate resolution and quality for screen display, typically 4-base images or as small as 400×400 pixels as they are never intended for reprint purposes. Transferred proxies are tagged with appropriate customer account information and are placed in an incoming album in the account of the customer, all without any further manual intervention from the retailer.

4) When the customer accesses an account over the internet, the central internet photo sharing community web site then displays the image proxies and is designed to support albuming and other common online operations plus proxy editing, cropping and compositions using the proxies rather than the original images. In the preferred embodiment, the central website converts all such operations (the “image processing” operations) to postscript where possible.

5) When a reprint is ordered, any image processing operations are sent with a unique reference to the originally scanned image (or images, if more than one image is used in a composition) to a print server at the print fulfilling location along with corresponding order identification and processing information.

6) Should the print fulfilling location be the same location where the film was originally scanned, the originally scanned image will already be local to the print server but if the fulfilling location is different from that where the original scan was made, the print server at the fulfilling location will automatically fetch the original image from the original scanning location or in the event that a multitude of images is required to complete the processing of a more complex composition, the print server will fetch suc multitude of images from any number of remote locations as necessary.

7) Now having the image processing operations and the original image (or images), the print server executes the processing operations against the original image(s) and produces the highest-possible quality enlargement or reprint. Note that communications bandwidth is only consumed by the transfer of the high-resolution images where a reprint has been ordered—and not by the transfer of all original scans as is the case with existing internet photofinishing systems linking with photo community sharing websites. Note also that although this method refers to reprints and enlargements, it is applicable to all photographic products like mugs, calendars, mousepads, photo-greeting cards, etc.

8) The originally scanned images will be automatically deleted over time as the local file servers manage their storage in conjunction with the central internet photo sharing community web site which will give customer viewing images time to decide if such customer wishes to pay for longer term, higher-security storage or other options for the original film scans. For example, 30 days prior to the flush of a given set of original scans, a customer could be offered individually priced packages to store all, or selected images for varying periods. Such payment would then offset the communication cost of moving the original scans to the central web site. Facilities at the central web site would then typically offer increased redundancy including options for optical backup and off-site storage.

9) Customers might also opt to combine a series of original scans onto one CD, ordered according to their desires, not according to frame number. The production of such CDs would then require the gathering of all original scans from various distributed local file servers but such communication cost for those specific images would be offset by the revenue from the sale of such CD. Should any image processing operations have been applied to the proxies, such would also be applied to the original images before writing to CD.

10) Customers who have special, “premium” online accounts might be offered special pan and zoom or other functionality requiring dynamic access to the original film scanned images and in such event, to meet this requirement, either the original image would be dynamically transferred to servers at the central internet photo sharing community site for appropriate retransmission to such customer, or such function would be provided directly by the file server holding the original image, but in either case, transparently to the customer.

11) It is also supported within this invention that a customer of a given scanning location would be able to order enlargements and other photographic products at the time of scanning which may not necessarily be fulfillable at the given scanning location. For example, the scanning location may have a digital minilab capable of only 4×6 output but the customer wishes 5×7's. In this case, the scanning location's file server could dynamically generate a print fulfillment request at any remote print server which would then fetch the original images from the scanning file server when such remote print server had available bandwidth and was queuing 5×7 print jobs.

The present invention can also be used to address memory problems associated with many digital cameras. These cameras often have flash memory cards for recording of the digital images. The number of images that can be stored is dependent upon the image quality but in many circumstances, there is a shortage of memory. To overcome this issue, a store outlet or kiosk can, for a fee, record the high quality images on a local server and transfer proxy images to the website. The user can then reuse the flash memory cards and repeat the process if necessary. This service is particularly valuable on trips where access to a personal computer or personal hard drive is not convenient, and the user can later decide when viewing his proxies on the community website, whether to purchase long term storage of the high-resolution original records, or to order reprints and other services in a manner identical to that whereby the original image records came from film scans instead of a digital source at the original retail location.

The present invention can also be used to address the sale of professional image content where such content might be hosted at a remote location with only proxy images made available to the public on photo sharing community websites. In the event that an image or composition is ordered which includes such professional content, the fulfilling location, having received the order with applicable image processing and composition information, will use the pointers within the order to make a direct connection to the source or sources of the original high-resolution image content and retrieve such content without the consumer having access to these originals in digital form. After fulfillment, the original images containing professional content would be deleted from the print servers unless an arrangement was in place whereby secure temporary storage was permitted by the content owners, and in this case, the high resolution originals would only be stored for a period related to the expectation that such content would be needed by the fulfiller on a frequent basis. In all cases, the pointers within the order allowing the fulfillment location to retrieve high resolution professional content would be provided under contract with such content owners, such contract might include the payment of a royalty for each print which would be tracked in accordance with the contract by the community website or fulfillment partner.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A system for storing film scans and providing access thereto on a photo sharing website, said system comprising a series of local computer servers storing film scans thereon with each local computer server including an arrangement for producing proxies of any of said stored film scans and a transmission arrangement for transmitting of said proxies to said photo sharing website where said proxies are of reduced accuracy and size; said remote photo sharing website receiving and storing said proxies and allowing a user remote access to at least some of said proxies by using said website.

2. A system as claimed in claim 1 wherein said photo sharing website includes a series of tools to allow a user to modify the proxies and produce an instruction set of said modifications, and means for sending of said instruction set to the local computer server having the original film scan used to produce said proxy.

3. A system as claimed in claim 2 wherein each of said local server computers includes means for retrieving a stored film scan associated with an instruction set received with respect to a particular proxy and means for modifying of the retrieved stored film scan in accordance with the instruction set and printing the modified film scan.

4. A system as claimed in claim 2 wherein said series of tools includes tools for cropping, image enhancement, compositing and editing.

5. A system as claimed in claim 2 wherein said local servers cooperate and accommodate transmission of original images therebetween where a local server receives an instruction set for an original image stored on a different local server.

6. A system as claimed in claim 2 wherein said local servers include means for recording original or modified original images to a removable storage media in accordance with user instructions.

7. A system as claimed in claim 6 wherein said removable storage media is a removable disk storage media.

8. A system as claimed in claim 2 wherein said photo sharing website includes the ability to form a sequence of proxies or modified proxies and provide an instruction set therefore to said local server and form a sequence of original or modified original scans in accordance with said instruction set.

9. A system as claimed in claim 8 wherein said sequence of original or modified original scans are recorded to a removable storage media.

10. A system as claimed in claim 8 wherein said sequence of original or modified original scans are made available as an internet slide presentation.

11. A system as claimed in claim 1 wherein said local server computers accommodate storage of original images for a first specified period of time and accommodate storage of specified original images for a second specified period of time which is greater than said first specified period of time.

12. A system comprising a series of local servers which stores digital images at a high quality, and a web server which receives reduced quality copies of said digital images and makes said images available to users over the internet; said web server allowing users to modify said digital images and order copies thereof produced from said high quality images, said web server upon receipt of order instructions sending instructions to any of said local servers to produce said order for transfer to said user by modifying said high quality images as specified by the user.

13. A method of storing, accessing, modifying and printing digital photographic comprising storing digital records in a high quality form on a local file server, producing a substantially lower quality copy of said digital records and transmitting to and posting on a website for access by an authorized user, providing on said website tools for modifying any of said images, recording of user instructions with respect to a modified image which he wants reproduced on a charge basis, forwarding said instructions to a retail outlet, retrieving corresponding high quality records associated with said instructions, and producing at said retail outlet said modified image using said high quality records and said instructions.

14. A method as claimed in claim 13 wherein said step of transmitting said lower quality record is transmitted over the internet to said web server.

15. A method as claimed in claim 13 wherein said local file server cooperates with other local file servers and transfers high quality records to any local server which has received instructions to produce a modified image.

16. A method as claimed in claim 13 including maintaining said records on said local file server only for a limited time unless instructions for long term storage are received.

17. A method as claimed in claim 13 wherein said step of producing said modified image prints said image.

18. A method as claimed in claim 13 wherein said step of producing said modified image stores said modified image on a compact disk.

19. A method as claimed in claim 13 wherein said step of producing said modified image stores said modified image on a storage medium specified by the user.

20. A system as claimed in claim 2 wherein said original file scans include digital images stored by a third party photo library and accessed as proxies from the photo sharing website.
